(19) United States
(12) Patent Application Publication
(10) Pub. No.: US 2015/0349704 A1
(43) Pub. Date: Dec. 3, 2015

(54) SOLAR PANEL CURTAIN DEVICE

(71) Applicant: LIMITED PARTNERSHIP JUAN ENERGY, Cheongju-si (KR)

(72) Inventor: JAE IL KIM, Cheongju-si (KR)

(73) Assignee: LIMITED PARTNERSHIP JUAN ENERGY, Cheongju-si (KR)

(21) Appl. No.: 14/760,511

(22) PCT Filed: Jul. 26, 2013
(86) PCT No.: PCT/KR2013/006702

§ 371 Date: Jul. 13, 2015

(30) Foreign Application Priority Data
Jan. 29, 2013 (KR) 10-2013-0009678

(51) Int. Cl. H02S 20/30; H02S 30/20; G01R 31/40; H02S 30/10

(52) U.S. Cl. CPC H02S 20/30; H02S 30/10; H02S 30/20; H02S 50/00

(57) ABSTRACT

According to one embodiment of the present invention, a solar panel curtain device comprises: a solar panel provided tilting at a predetermined angle relative to the ground surface, corresponding to the angle of incidence of sunlight; a first roll housing provided at the lower edge of the solar panel, having formed therein a first rotational shaft and a solar panel curtain accommodating space, and having formed on one side thereof a slot adapted such that the solar panel curtain can withdraw into the inner accommodating space or advance out of the inner accommodating space; a second roll housing provided at the upper edge of the solar panel, and having formed therein a second rotational shaft; a first rail and a second rail respectively touching the two ends of the first rotational shaft and the two ends of the second rotational shaft, and performing rotational motions on two sides of the solar panel; and a panel curtain of which the ends on both sides respectively touch the first rail and the second rail, and which operates so as either to be stowed in the inner accommodating space of the first roll housing or to cover the solar panel, in accordance with the rotational motions of the first rail and the second rail.

### TECHNICAL FIELD

The present invention relates to a solar panel curtain device and, more particularly, to a solar panel curtain device that can maximize the life of the panel and the power generation efficiency by covering the solar panel automatically and protecting the solar panel from foreign substances and weather phenomena such as snow and sandy dust.

### Background Art

Methods of using solar energy are generally divided into two methods, a method of using solar heat and a method of using solar light. The method of using solar heat utilizes water heated by sun for heating and power generation. The method of using solar light, so called solar-light power generation, generates electricity by using solar light and operates various machines and apparatuses with the electricity.

The solar-light power generation generates electricity by utilizing photovoltaic effect which generates an electromotive force by electrons-holes with the light energy when sun light illuminates to a solar panel in which p-n junctions are formed with n-doped crystalline silicone.

For this purpose, solar cells for concentrating sunlight, a photovoltaic module which is a collection of solar cells, and a solar array which arranges solar cells in regular patterns are required.

As an example, an electron of the conduction band of p-type semiconductors is excited into the valance band by the light energy of incident light when sunlight illuminates to a photovoltaic module. The excited electron forms an electron-hole pair (EHP) inside p-type semiconductors. The electron of the EHP transfers to a n-type semiconductor by an electron field existing between p-n junctures and supplies electricity to the outside.

Meanwhile, in case of polycrystalline silicon material which is currently mostly used, the efficiency of a module of solar-light power generation is approximately within a range of 16% to 18% and is one of the most important factor in determining the economic feasibility of solar-light power generation. In order to enhance the efficiency continuously, it is essential to maintain and repair the module through various apparatuses.

However, since solar cells for concentrating sunlight, the solar module and the solar array are installed in the outside and exposed to external environment, dust scattering, bird feces, sand dust, and other contaminating substances are attached to them, and thereby reduce the amount of concentrated light decreasing the efficiency.

Especially in the winter season, snow covers the solar cells, the photovoltaic module and the solar array, as foreign substances are attached, reducing the amount of concentrated light and decreasing the efficiency. Furthermore, the efficiency of power generation decreases because the temperature increases due to a long period of exposure to sunlight and thus electromotive force reduces.

In order to resolve these problems, some efficiency enhancing devices have been used recently. These efficiency enhancing devices are a cleaning device for solar array using a mechanical force such as vehicle brush, a cleaning device for solar array using water flow through a water hose installed in an upper part of the solar array, a cleaning device for solar array ejecting high-pressure water through separate nozzles, and so forth.

The cleaning device using a brush has disadvantages that a special brush appropriate for the maintenance system of solar-light power generation should be manufactured and it does not provide a way of cooling when the solar array is overheated. The cleaning device using water flow via gravity has a disadvantage that it is not that effective in eliminating contaminating substances or snow.

Accordingly, the cleaning device ejecting high-pressure water through separate nozzles has been tried recently to cool and clean solar arrays. This cleaning device, however, requires high installation and operation cost in maintaining high pressure required for cooling and cleaning because the nozzle part ejecting water is generally fixed and not rotatable, requiring many nozzles in case the area of solar array is large.

Moreover, in case water is ejected randomly with fixed nozzles, a large amount of water may be wasted because it is difficult to eject water to a desired area. In addition, because the piping for adjusting ejection angle of the nozzles casts shadows on the solar array, the efficiency of the power generation decreases or a larger area is required due to a longer distance between the solar arrays. The shadows on photovoltaic modules incur a hot spot effect which causes a sharp decline of the power of solar cells connected in serial within the modules and thus should be surely avoided.

In particular, in case of solar arrays formed in a large scale, because the numbers of nozzles for cooling and cleaning increase accordingly, there exists a difficult task that a sufficient efficiency for snow-removing, cooling, and cleaning should be achieved by avoiding the shadows, ejecting water to photovoltaic modules with an appropriate pressure, and effectively using a limited water resource. Also, in the winter season, there is a problem that the power generation efficiency decreases due to a rapid reduction of power generation when snow covers the upper surface of the solar array.

### DETAILED DISCLOSURE

### Technical Problem

The present invention has been developed to improve the conventional art, and an object of the present invention is to provide a solar panel curtain device that maximizes the life of the panel and the power generation efficiency by covering the solar panel automatically and protecting the solar panel from foreign substances and weather phenomena such as snow and sandy dust.

### TECHNICAL SOLUTION

In order to resolve the problem of the conventional art, a solar panel curtain device according to an embodiment of the present invention comprises: a solar panel provided tilting at a predetermined angle relative to the ground surface, corresponding to the angle of incidence of sunlight; a first roll housing provided at the lower edge of the solar panel, having formed therein a first rotational shaft and an inner accommodating space, and having formed at one side thereof a slot adapted such that a panel curtain can withdraw into the inner accommodating space or advance out of the inner accommodating space; a second roll housing provided at the upper edge of the solar panel, and having formed therein a second rotational shaft; a first rail and a second rail connecting two ends of the first rotational shaft and two ends of the second rotational shaft and performing rotational motions at two sides of the solar panel, respectively at a different side each other; and the panel curtain of which the ends on both sides respectively touch the first rail and the second rail, and which operates so as either to be stowed in the inner accommodating space of the first roll housing or to cover the solar panel, in accordance with the rotational motions of the first rail and the second rail.

Furthermore, a solar panel curtain device according to an embodiment of the present invention further comprises a scraper provided at a predetermined distance from an upper part of the first roll housing, the scraper guiding the panel curtain into the inner accommodating space of the first roll housing through the slot between the first and second rails.

In addition, a solar panel curtain device according to an embodiment of the present invention further comprises one or more load sensors provided at both ends of the solar panel, the load sensors configured to touch the lower surface of the first rail and the lower surface of the second rail and measure loads delivered from the first rail and the second rail, respectively; a motor configured to deliver power to the first rotational shaft; and a motor controller configured to compare the measured value with a selected reference range and, if the measured value is within the reference range, control the motor in such a way that the panel curtain enters into the inner accommodating space of the first roll housing through the slot according to the rotations of the first rail and the second rail.

Moreover, a solar panel curtain device according to an embodiment of the present invention further comprises a motor configured to deliver power to the first rotational shaft; and a motor controller configured to connect through communications network to an external server or terminal which provides weather information and control the motor corresponding to the weather information in such a way that the panel curtain covers the solar panel or enters into the inner accommodating space of the first roll housing.

### ADVANTAGEOUS EFFECTS

According to the present invention, the present invention provides a solar panel curtain device that maximizes the efficiency of the power generation by protecting solar panels from foreign substances such as snow or sand dust, etc. through a panel curtain that covers the solar panels.

Furthermore, a solar panel curtain device according to the present invention provides snow-removal function for a solar panel system through a scraper installed with the panel curtain, by automatically sweeping snow accumulated on the panel curtain out to the ground with a sliding motion of the panel curtain.

In addition, a solar panel curtain device according to the present invention, by making the panel curtain to cover the solar panel automatically corresponding to the weather information received from a weather information providing server, can keep the solar panel at the optimum condition corresponding to the weather situation without requiring the administrator's work.

Moreover, a solar panel curtain device according to the present invention can protect the solar panel from weather phenomena more efficiently by measuring the pressure caused by accumulated snow on the panel curtain and informing it to the administrator or removing snow automatically.

### DESCRIPTION OF DRAWINGS

FIG. 1 is a perspective view illustrating a solar panel curtain device according to one embodiment of the present invention.

FIG. 2 is a perspective view illustrating a solar panel curtain device with a panel curtain covered thereon according to one embodiment of the present invention.

FIG. 3 illustrates an operation of a solar panel curtain device according to one embodiment of the present invention in which snow accumulated in the upper surface of the panel curtain is being removed.

FIG. 4 is a block diagram illustrating a configuration of a solar panel curtain device according to one embodiment of the present invention.

### MODE FOR INVENTION

In a solar panel curtain device according to the present invention, a panel curtain can be configured to move to cover an upper part of a solar panel. The movement of the panel curtain of the solar panel curtain device can be implemented to protect the solar panel from foreign substances such as snow or sand dust. As such, the solar panel curtain device according to the present invention can be implemented to protect the solar panel from various external environments. This disclosure describes, as an example for the convenience of explanation, a case that the solar panel curtain device is used to protect the solar panel from snow and performs snow-removal automatically under a weather condition involving snowfall.

Hereinafter, some embodiments of the present invention will be described in detail with reference to the accompanying drawings.

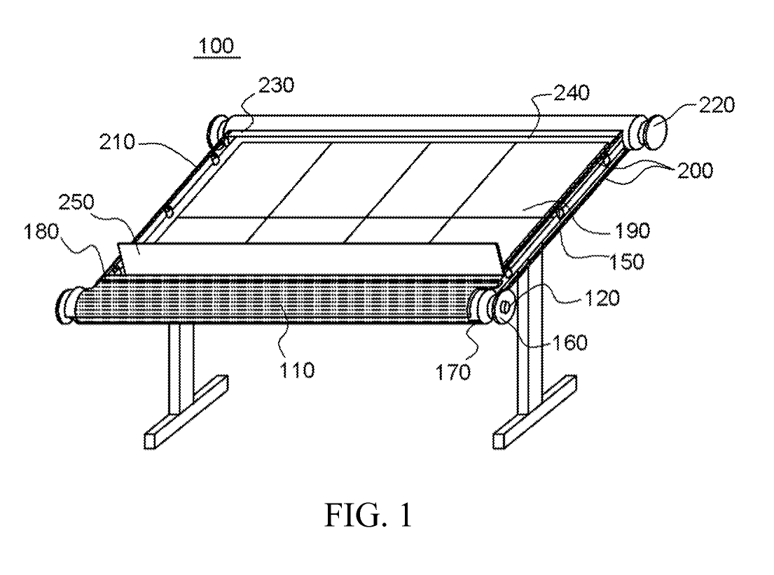

FIG. 1 is a perspective view illustrating a solar panel curtain device according to one embodiment of the present invention.

A solar panel curtain device 100 according to the present invention comprises a panel curtain 110, a motor 120, a load sensor 150, a first roll housing 160, a first slot 170, a scraper 180, a solar panel 190, a first rail 200, a second rail 210, a second roll housing 220, a second slot 230, a frame 240, and a blocking panel 250.

The panel curtain 110 is formed to have a predetermined width and can cover the edges of the frame 240. The blocking panel 250 can be formed at one end of the panel curtain 110. The blocking panel 250 can be formed to have a predetermined width and the width can correspond to the length of the first slot 170 formed in the first roll housing 160. Also, it can prevent snow from falling on the upper surface of the panel curtain 110. The frame 240 surrounds the edges of the solar panel 190 and may have one or more installation supports being formed at the lower surface thereof The first roll housing 160 is provided at the lower edge of the frame 240. The panel curtain 110 can withdraw into or advance out of the inner part of the first roll housing 160 through the first slot 170 formed at one side of the first roll housing 160. The first rail 200 and the second rail 210 can be formed at each end of the first roll housing 160 respectively.

The upper surface of the first rail 200 and the second rail 210 may touch the panel curtain 110. One or more load sensors 150 may be installed in the lower surface of the first rail 200 and the second rail 210. In case the panel curtain 110 covers the solar panel 190, the weight of snow accumulated on the surface of the panel curtain can be measured in real time with the one or more load sensors 150. The scraper 180 can be installed in the lower surface of the panel curtain 110 and at one side of the first roll housing 160. The cross section of the scraper 180 is configured to correspond to the one side of the first roll housing 160 and to have a predetermined length.

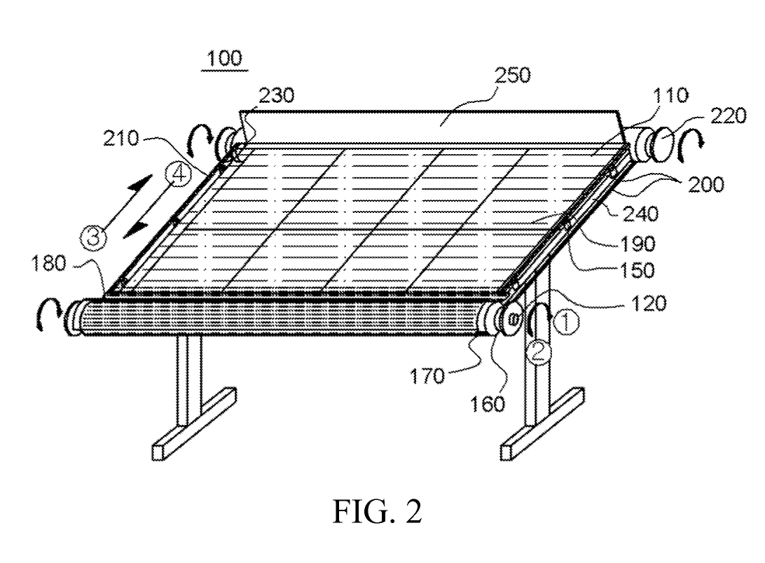

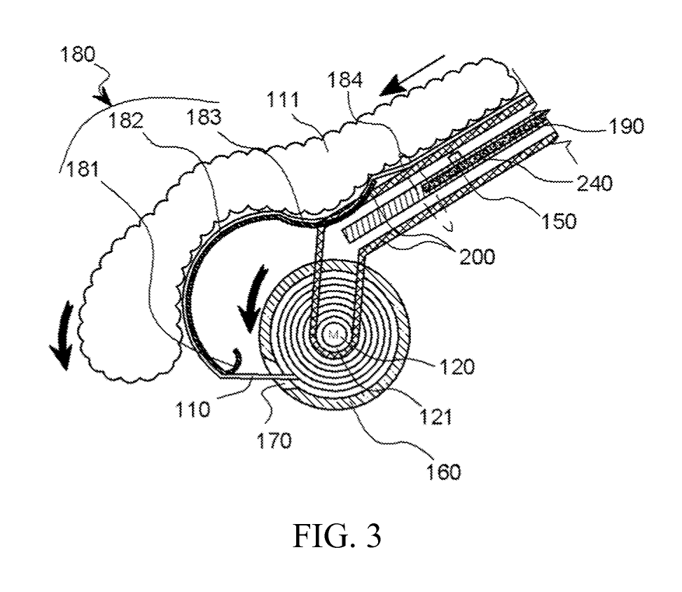

The motor 120 can be installed in one end of the first roll housing 160. The way that the panel curtain operates due to the motor motion is described in detail with reference to FIG. 2 and FIG. 3. The second roll housing 220 can be installed in the upper edge of the solar panel 190. The panel curtain 110 can withdraw into or advance out of the inner part of the second roll housing 220 through the second slot 230 formed at one side of the second roll housing 220. The first rail 200 and the second rail 210 can be formed at each end of the second roll housing 220 respectively.

FIG. 2 is a perspective view illustrating a solar panel curtain device with a panel curtain covered thereon according to one embodiment of the present invention.

The motor 120 can be installed in one end of the first roll housing 160. The motor 120 delivers power to the rotational shaft 121. The rotational shaft 121 rotates by the delivered power. According to the rotation of the rotational shaft 121, the first rail 200 and the second rail 210 which connect with both ends of the rotational shaft 121 move in an elliptic path between the first roll housing 160 and the second roll housing 220.

The panel curtain 110 can be transferred in a direction from the first roll housing 160 to the second roll housing 220 according to the motion of the first rail 200 and the second rail 210. In this case, the motor 120 rotates in the direction as direction \textcircled{1} and the panel curtain 110 moves in the direction as direction \textcircled{3}. The panel curtain 110 transferred along the direction \textcircled{3} can advance to the entry of the second slot 230 with a predetermined length formed at one side of the second roll housing 220. Thus, the length of the panel curtain 110 can be determined in such a way that the edge thereof reaches to the entry of the second slot 230 when the panel curtain 110 is transferred in a direction from the first roll housing 160 to the second roll housing 220.

The panel curtain 110 can be transferred in a direction from the second roll housing 220 to the first roll housing 160. In this case, the motor 120 rotates in the direction as direction \textcircled{2} and the panel curtain 110 moves in the direction as direction \textcircled{4}. A part of the panel curtain 110 can be accommodated into the inner space of the first roll housing 160 through the first slot 170 when the panel curtain 110 is transferred in a direction from the second roll housing 220 to the first roll housing 160. The second roll housing 220 can be installed at the upper edge of the solar panel 190. The panel curtain 110 can withdraw into or advance out of the inner part of the second roll housing 220 through the second slot 230 formed at one side of the second roll housing 220. The first rail 200 and the second rail 210 can be formed at each end of the second roll housing 220 respectively.

FIG. 3 illustrates an operation of a solar panel curtain device according to one embodiment of the present invention in which snow accumulated in the upper surface of the panel curtain is being removed.

The rotational shaft 121 can be accommodated into the inner space of the first roll housing 160 and the motor 120 can be accommodated into the inner part of the rotational shaft 121. If the rotation direction of the rotational shaft 121 is counterclockwise, the panel curtain 110 can be accommodated into the inner space of the first roll housing 160 according to the rotation of the rotational shaft 121, surrounding the rotational shaft 121. Also, if the rotation direction of the rotational shaft 121 is clockwise, the panel curtain 110 can be transferred toward the second roll housing 220, which is a direction to the upper edge of the solar panel 190, along the first rail 200 and the second rail 210 according to the rotation of the rotational shaft 121, unwinding from the rotational shaft 121.

The scraper 180 can be implemented to comprise a first arc 181, a second arc 182, and a third arc 183. That is, the scraper 180 can be implemented to have a side having three combined arcs.

The panel curtain 110 can be layered on the upper surface of the scraper 180. When the panel curtain 110 covering the solar panel 190 is transferred to the lower edge due to counterclockwise rotation of the rotational shaft 121, the panel curtain 110 can be accommodated into the inner space of the first roll housing 160 via the first arc 181, the second arc 182, and the third arc 183 of the scraper 180.

The length of the panel curtain 110 can be determined in such a way that, when the panel curtain 110 is accommodated into the inner space of the first roll housing 160 at its maximum, the end of the panel curtain 110 is positioned at a first position 184 located at an upper region than the third arc 183. The first position 184 can be determined to be a position where the solar panel 190 ends in a direction toward the lower edge of the frame 240. With this configuration, the light collection efficiency can be maximized by removing overlapping area between the solar panel 190 and the panel curtain 110 in case the panel curtain 110 is accommodated into the inner space of the first roll housing 160.

On this wise, snow 111 accumulated on the panel curtain 110 can be transferred to the lower edge according to the movement of the panel curtain 110. Snow 111 passed through the first position 184 falls down to the ground via the third arc 183 and the second arc 182.

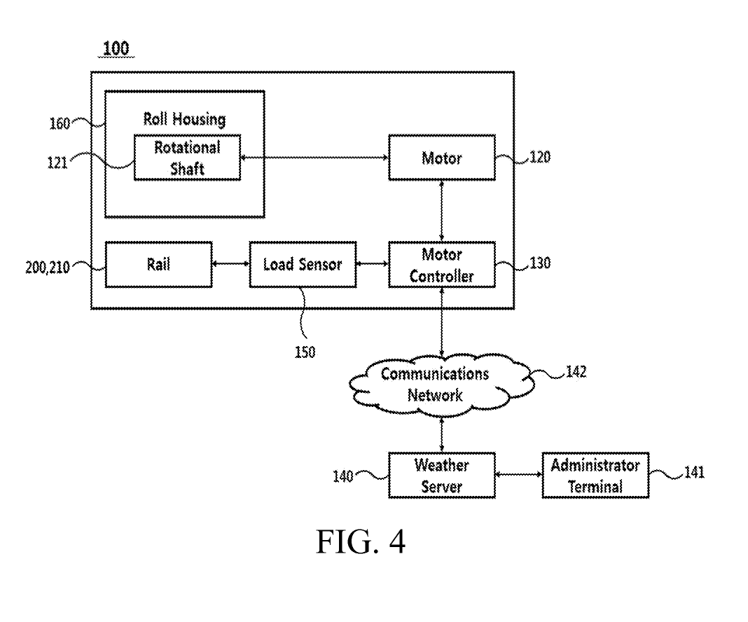

The load sensor 150 can be installed in the frame 240 at the both ends of the solar panel 190. The load sensor 150 can measure the pressure delivered by snow accumulated on the upper surface of the frame. Snow-removal by the movement of the panel curtain 110 can be performed according to the measured pressure. This is explained in detail with reference to FIG. 4.

FIG. 4 is a block diagram illustrating a configuration of a solar panel curtain device according to one embodiment of the present invention.

A solar panel curtain device 100 according to one embodiment of the present invention comprises a roll housing 160, a rotational shaft 121, a motor 120, a first rail 200, a second rail 210, a load sensor 150, and a motor controller 130.

The motor 120 can be operated by various inputs. For example, it can be operated by the administrator's input, it can be operated according to the loads that are delivered on the panel curtain 110, or it can be operated by information received from outside.

As described in detail above, the load sensor 150 can measure the pressure delivered on the solar panel 190 by snow 111 in case snow 111 is accumulated on the solar panel 190. The motor 120 can be operated according to the measured pressure. For this purpose, the motor controller 130 can compare the measured pressure with a predetermined reference range. If, after comparison, the measured pressure is within the reference range, the motor controller 130 can control the operation of the motor 120 in such a way that the panel curtain 110 is transferred to the lower edge. Accordingly, snow accumulated on the panel curtain 110 falls down to the ground.

Furthermore, the motor controller 130 can connect to an external weather server 140 or administrator's terminal 141 through a communications network 142. The communications network 142 can be implemented through a mobile communications network such as CDMA, GSM, LTE and a wire-wireless internet network. If the motor controller 130 receives weather information such as heavy-snowfall watch or heavy-snowfall warning from the weather server 140, it can control the operation of the motor 120 in such a way that the panel curtain 110 is transferred to the upper edge of the solar panel 190 covering the solar panel 190. In addition, when the pressure measured by the load sensor 150 is larger than the reference value or when it receives weather information such as heavy-snowfall watch from the weather server 140, it can transmit a message including such information to the administrator terminal 141.

Although the present invention is described with reference to limited embodiments and figures, the present invention is not limited to the embodiments and it is possible for a person having ordinary skill in the art to implement diverse modifications and variations from this disclosure.

Therefore, the scope of the present invention should not be limited to the described embodiments, but should be determined by the appended claims below and their equivalents.

What is claimed is:

1. A solar panel curtain device comprises:
a solar panel provided tilting at a predetermined angle relative to the ground surface, corresponding to the angle of incidence of sunlight;
a first roll housing provided at the lower edge of the solar panel, having formed therein a first rotational shaft and an inner accommodating space, and having formed at one side thereof a slot adapted such that a panel curtain can withdraw into the inner accommodating space or advance out of the inner accommodating space;
a second roll housing provided at the upper edge of the solar panel, and having formed therein a second rotational shaft;
a first rail and a second rail connecting two ends of the first rotational shaft and two ends of the second rotational shaft and performing rotational motions at two sides of the solar panel, respectively at a different side each other; and
the panel curtain of which the ends on both sides respectively touch the first rail and the second rail, and which operates so as either to be stowed in the inner accommodating space of the first roll housing or to cover the solar panel, in accordance with the rotational motions of the first rail and the second rail.

2. The solar panel curtain device of claim 1, further comprising a scraper provided at a predetermined distance from an upper part of the first roll housing, the scraper guiding the panel curtain into the inner accommodating space of the first roll housing through the slot between the first and second rails.

3. The solar panel curtain device of claim 1, further comprising:
one or more load sensors provided at both ends of the solar panel, the load sensors configured to touch the lower surface of the first rail and the lower surface of the second rail and measure loads delivered from the first rail and the second rail, respectively;
a motor configured to deliver power to the first rotational shaft; and
a motor controller configured to compare the measured value with a selected reference range and, if the measured value is within the reference range, control the motor in such a way that the panel curtain enters into the inner accommodating space of the first roll housing through the slot according to the rotations of the first rail and the second rail.

4. The solar panel curtain device of claim 1, further comprising:
a motor configured to deliver power to the first rotational shaft; and
a motor controller configured to connect through communications network to an external server or terminal which provides weather information and control the motor corresponding to the weather information in such a way that the panel curtain covers the solar panel or enters into the inner accommodating space of the first roll housing.
